(19) United States
(12) Patent Application Publication
(10) Pub. No.: US 2025/0078356 A1
(43) Pub. Date: Mar. 6, 2025

(54) METHOD OF GENERATING COMIC IMAGE, COMPUTER DEVICE AND STORAGE MEDIUM

(71) Applicant: Beijing Zitiao Network Technology Co., Ltd., Beijing (CN)

(72) Inventors: Fei DING, Beijing (CN); Qi SONG, Beijing (CN); Qi WANG, Beijing (CN); Xinhui LEI, Beijing (CN)

(21) Appl. No.: 18/780,289

(22) Filed: Jul. 22, 2024

(30) Foreign Application Priority Data
Aug. 31, 2023 (CN) 202311118761.2

(51) Int. Cl. G06T 11/60; G06F 40/30

(52) U.S. Cl. CPC G06T 11/60; G06F 40/30

(57) ABSTRACT

A method of generating a comic image, a computer device and a storage medium are provided. The method includes: acquiring a target novel to be used to generate a comic; determining keyword information corresponding to comic storyboards that correspond to the target novel in a plurality of comic image generation dimensions according to a content of the target novel; with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords include a keyword that has been determined in any comic image generation dimension; and using an artificial intelligence model to generate a comic image corresponding to the comic storyboard according to the target model input information.

### CROSS-REFERENCE TO RELATED APPLICATION

The present application claims priority of the Chinese Patent Application No. 202311118761.2, filed on Aug. 31, 2023, the disclosure of which is incorporated herein by reference in its entirety as part of the present application.

### TECHNICAL FIELD

The present disclosure relates to a method of generating a comic image, a computer device and a storage medium.

### BACKGROUND

Comics are favored by the majority of readers because of the advantages of interesting contents, convenient reading and intuitive expression. Therefore, there are growing demand for converting a novel or a wonderful novel plot into a comic. In the production scenario of converting a novel into a comic, the comic script structure is split out according to the content of the novel, and then use the comic script structure to generate standard comic images.

However, in regular methods for comic image generation, most of the regular methods use the manual method to generate the standard comic images according to the comic script structure, which consumes a large amount of time cost and labor cost, and reduces the efficiency of generating comic images.

### SUMMARY

Embodiments of the present disclosure provide at least a method and apparatus of generating a comic image, a computer device and a storage medium.

The embodiments of the present disclosure provide a method of generating a comic image, which includes:
acquiring a target novel to be used to generate a comic;
determining keyword information corresponding to comic storyboards that correspond to the target novel in a plurality of comic image generation dimensions according to a content of the target novel;
with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords is keywords that have been determined in any comic image generation dimension; and
using an artificial intelligence model to generate the comic image corresponding to the comic storyboard according to the target model input information.

In a possible implementation, the keyword information includes at least one target keyword; the mapping relationship library is used for storing different mapping relationships between the dimension keywords and the model input information;
the determining target model input information corresponding to the comic storyboard according to a mapping relationship library between dimension keywords and model input information, and the keyword information of the comic storyboards in the comic image generation dimensions, includes:
when a target mapping relationship that matches the target keyword included in the keyword information is searched from the mapping relationships included in the mapping relationship library, taking model input information indicated by the target mapping relationship as the target model input information.

In a possible implementation, the target mapping relationship is searched as following steps:
taking a mapping relationship corresponding to a dimension keyword that is consistent with the target keyword in the mapping relationship library as the target mapping relationship;
or, determining the target mapping relationship according to correlation degrees between keyword semantics of the dimension keywords of the mapping relationships in the mapping relationship library and a target semantic of the target keyword.

In a possible implementation, the determining target model input information corresponding to the comic storyboard according to a mapping relationship library between dimension keywords and model input information, and the keyword information of the comic storyboards in the comic image generation dimensions, includes:
when the mapping relationship library does not store a target mapping relationship that matches a target keyword included in the keyword information, determining pieces of candidate input information corresponding to the target keyword;
inputting each candidate input information into the artificial intelligence model separately to obtain target images corresponding to each candidate input information; and
determining the target model input information from the candidate input information according to matching degrees between the target images and the keyword information.

In a possible implementation, after determining the target model input information from the candidate input information, the method further includes:
establishing a mapping relationship between the target model input information and the target keyword, and storing the mapping relationship between the target model input information and the target keyword into the mapping relationship library.

In a possible implementation, the determining target model input information corresponding to the comic storyboard according to a mapping relationship library between dimension keywords and model input information, and the keyword information of the comic storyboards in the comic image generation dimensions, includes:
when the mapping relationship library does not store a target mapping relationship that is related to a target keyword included in the keyword information, determining pieces of candidate input information corresponding to the target keyword;
with respect to anyone of the candidate input information, using a plurality of text-and-image conversion models separately to generate corresponding target images according to the candidate input information, wherein different text-and-image conversion models are deployed with different text-and-image conversion algorithms; and
determining an image generation effect of the candidate input information according to the target images, and determining the target model input information corresponding to the comic storyboard according to the image generation effect of the candidate input information respectively.

In a possible implementation, the determining keyword information corresponding to comic storyboards that correspond to the target novel in a plurality of comic image generation dimensions according to a content of the target novel, includes:
determining occurrence numbers of each storyboard scene corresponding to the target novel according to the content of the target novel; and
determining the keyword information separately corresponding to the comic storyboards that corresponds to the target novel in the plurality of the comic image generation dimensions according to the occurrence numbers, wherein an information amount of the keyword information is positively correlated with the occurrence number.

In a possible implementation, after generating the comic images corresponding to the comic storyboards, the method further includes:
determining storyboard frames corresponding to the comic storyboards according to the keyword information corresponding to each of the comic storyboards;
filling the comic images corresponding to each of the comic storyboards in the storyboard frames to obtain storyboard images corresponding to each of the comic storyboards; and
according to a target number of episodes to which each of the comic storyboards belongs in a strip comic and a storyboard order of each of the comic storyboards in the target number of the episodes, typesetting the storyboard images corresponding to the comic storyboards to obtain a target strip comic corresponding to the target novel.

In a possible implementation, the comic storyboards corresponding to the target novel is determined as following steps:
splitting the target novel according to information semantics of text information corresponding to the target novel, and obtaining novel segments corresponding to the target novel; and
determining the comic storyboards corresponding to the target novel according to segmented texts of the novel segments and the comic image generation dimensions.

In a possible implementation, the comic image generation dimensions are determined as following steps:
determining a novel genre of the target novel; and
determining the plurality of the comic image generation dimensions corresponding to the target novel from a plurality of preset image generation dimensions according to the novel genre.

The embodiments of the present disclosure further provide an apparatus of generating a comic image, which includes an acquiring module, the first determining module, the second determining module and the first generating module.

The acquiring module is configured to acquire a target novel to be used to generate a comic.

The first determining module is configured to determine keyword information corresponding to comic storyboards that correspond to the target novel in a plurality of comic image generation dimensions according to a content of the target novel.

The second determining module is configured to, with respect to any comic storyboard of the comic storyboards, determine target model input information corresponding to the comic storyboard according to a mapping relationship library between dimension keywords and model input information, and the keyword information of the comic storyboards in the comic image generation dimensions. The dimension keywords comprise a keyword that has been determined in any comic image generation dimension.

The first generating module is configured to use an artificial intelligence model to generate a comic image corresponding to the comic storyboard according to the target model input information.

The embodiments of the present disclosure further provide a computer device, which includes at least one processor and a memory. The memory stores machine-readable instructions executed by the at least one processor, the at least one processor is configured to execute the machine-readable instructions stored in the memory, and when the machine-readable instructions are executed by the at least one processor, the at least one processor executes steps of anyone of possible implementations in the above-mentioned method of generating a comic image.

The embodiments of the present disclosure further provide a non-transitory computer-readable storage medium. The non-transitory computer-readable storage medium stores computer programs, and when the computer programs are executed by a computer device, the computer device executes steps of anyone of possible implementations in the above-mentioned method of generating a comic image.

The description of effects of the above-mentioned apparatus of generating a comic image, the computer device and the storage medium, refers to the illustration of the above-mentioned method of generating a comic image, which is not repeated here.

In order to make the above-mentioned purposes, features and advantages of the present disclosure more obvious and understandable, better embodiments are provided below with the accompanying drawings, and the details are illustrated below.

### BRIEF DESCRIPTION OF DRAWINGS

In order to illustrate the technical solutions of the embodiments of the present disclosure more clearly, the drawings required to be used in the embodiments are briefly introduced below. The drawings are incorporated into the specification and form a part of the specification. The drawings show the embodiments that conform to the present disclosure, and are used together with the specification to illustrate the technical solutions of the present disclosure. It should be understood that the following drawings only show some embodiments of the present disclosure, and therefore should not be regarded as a limitation of the scope. Other related drawings can also be derived from these drawings by those ordinarily skilled in the art without creative efforts.

FIG. 1 shows a flowchart of a method of generating a comic image provided in an embodiment of the present disclosure;

FIG. 2 shows a schematic diagram of a storyboard frame provided in an embodiment of the present disclosure;

FIG. 3 shows a schematic diagram of a strip comic of a target episode provided in an embodiment of the present disclosure;

FIG. 4 shows a schematic diagram of an apparatus of generating a comic image provided in an embodiment of the present disclosure; and

FIG. 5 is a structural schematic diagram of a computer device provided in an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, instead of all the embodiments. The components of the embodiments of the present disclosure that are typically described and shown here, may be deployed and designed in a variety of different configurations. Therefore, the following detailed description of the embodiments of the present disclosure is not intended to limit the scope of the present disclosure claimed, but merely represents the selected embodiments of the present disclosure. Based on the embodiments of the present disclosure, all other embodiments obtained by those ordinarily skilled in the art without creative efforts belong to the scope of protection of the present disclosure.

In addition, the terms “first”, “second”, etc., in the specification and claims in the embodiments of the present disclosure and in the above-mentioned drawings are used to distinguish similar objects, and are not necessarily used to describe a specific order or sequence. It should be understood that the data thus used are interchangeable in the suitable case, so that the embodiments described here can be implemented in an order other than the order illustrated or described here.

References to “a plurality of or several” in the present article refer to two or more than two. “And/or” describes the correlation between the associated objects, and indicates that there may be three relationships. For example, A and/or B, may indicate that A exists alone, A and B exist at the same time, and B exists alone. The character “/” generally indicates that the relationship between the preceding and posting objects is “or”.

It is found that when converting a novel or a wonderful novel plot into a comic, the artist often needs to draw the comic manually according to the content of the novel. Although it can implement the conversion from the novel to the comic, it consumes high labor cost and time cost, which affects the efficiency of generating the comic.

Based on the above research, the present disclosure provides a method and apparatus of generating a comic image, a computer device and a storage medium. By determining the keyword information corresponding to comic storyboards that corresponds to a target novel in a plurality of comic image generation dimensions, the method can not only implement the storyboard process of the target novel, but also implement the fine-grained division of the target novel, and obtain the keyword information of the fine-grained sizes corresponding to the comic storyboards. Because model input information can control a content of an image generated by an artificial intelligence (AI) model, and the accuracy of the model input information may directly affect the image generation effect of the artificial intelligence model, by using keyword information and a mapping relationship library that stores mapping relationships between dimension keywords and model input information, the target model input information corresponding to the comic storyboards can be determined quickly and accurately. Then, by using the target model input information corresponding to the comic storyboards, the comic images corresponding to the comic storyboards can be obtained accurately, thereby implementing using the target novel to generate a comic quickly and accurately. Moreover, the process of generating comic images from the target novel is completely automated execution process without human participation, which effectively improve the speed and efficiency of generating comic images from a novel.

Defects existing in the above solutions derive from the practice and careful research of inventors. Therefore, the discovery process of the above-mentioned problems and the solutions to the above-mentioned problems proposed below by the present disclosure should be deemed as the contribution of the inventors to the present disclosure in the course of the present disclosure.

It should be noted that similar numerals and letters in the drawings below indicate similar items. Therefore, once an item is defined in a drawing, the item does not need to be further defined and explained in subsequent drawings.

It is understandable that before using the technical solutions disclosed in the embodiments of the present disclosure, the type, scope of use, and use scenarios of the personal information involved in the present disclosure shall be informed to the user and the authorization shall be obtained from the user through appropriate methods in accordance with relevant laws and regulations.

It should be illustrated that specific term mentioned in the embodiments of the present disclosure includes “prompt”.

Prompt is an artificial intelligence (AI) prompt word, which is a method that uses a natural language to guide or motivate an AI model to complete a specific task. The prompt is used to prompt the AI model with the context of the input information and the parameter information of the input model, which can help the model better understand the intent of the input and provide the corresponding output.

In order to help understand the present embodiment, a method of a generating comic image disclosed in the embodiments of the present disclosure is first introduced in detail, and the execution subject of the method of generating the comic image provided in the embodiments of the present disclosure is generally a terminal device or another processing device with certain computing capability. The terminal device may be a user equipment (UE), a mobile device, a user terminal, a terminal, or a personal digital assistant device (PDA), a handheld device, a computer device, or the like. In some possible implementations, the method of generating a comic image may be implemented by a processor calling computer-readable instructions stored in a memory.

The method of generating a comic image provided in the embodiments of the present disclosure is illustrated below by taking a computer device as the execution subject.

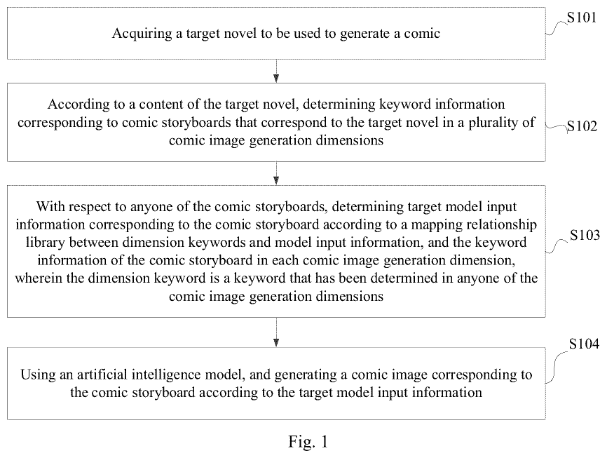

As shown in FIG. 1, which shows a flowchart of a method of generating a comic image provided in an embodiment of the present disclosure, the method may include the following steps:

S101: acquiring a target novel to be used to generate a comic.

Here, the target novel is a novel used to generate a comic. Specifically, the target novel may be a novel of any genre, or may be any chapter or fragment of any novel.

In a specific implementation, for any novel, when there is a novel to be converted into a strip comic, the novel can be taken as the target novel. After that, any computer device with novel-to-comic function can be used to acquire the target novel.

S102: according to a content of the target novel, determining keyword information corresponding to comic storyboards that correspond to the target novel in a plurality of comic image generation dimensions.

Here, the comic storyboards use the form of a diagram to illustrate the composition of a comic image corresponding to the target novel, wherein information such as the camera movement, the time duration, the dialogue, the effect, etc. are at least marked. A comic storyboard may be understood as a shot split from the target novel, a comic storyboard corresponds to a comic image, and the comic images corresponding to different storyboards are different.

The comic image generation dimensions are various information dimensions that are used to assist in generating comic images, and the keyword information in the comic image generation dimensions are extracted from the content of the target novel. For any comic storyboard, the keyword information of the comic storyboards in the comic image generation dimensions can characterize the image content included in the comic image corresponding to the comic storyboard. It may be understood that for some comic storyboards, there may be a comic image generation dimension whose keyword information is empty.

In one embodiment, the comic image generation dimensions corresponding to the target novel may be determined as following steps:
determining a novel genre of the target novel; and determining the plurality of the comic image generation dimensions corresponding to the target novel from a plurality of preset image generation dimensions according to the novel genre.

Here, the novel genre may include, for example, romance, martial arts, comedy, ancient costume, science fiction, suspense, drama, and other genres. The preset image generation dimension is an image generation dimension set in advance. Different novel genres can use different preset image generation dimensions for extracting the keyword information, and a novel genre can correspond to the plurality of the preset image generation dimensions.

In a specific implementation, after acquiring the target novel, the novel genre of the target novel can be determined first. Then, preset image generation dimensions that match the novel genre may be filtered out from a plurality of preset image generation dimensions and taken as the comic image generation dimensions corresponding to the target novel. For example, correlation degrees between various novel genres and various preset image generation dimensions may also be predetermined, and after determining the novel genre of the target novel, the plurality of the comic image generation dimensions corresponding to the target novel may be filtered out from the plurality of the preset image generation dimensions according to the correlation degrees. For example, when the preset image generation dimensions include dimensions 1 to 30, if the novel genre is the genre 1, then the dimensions 1 to 16 may be taken as the comic image generation dimensions; if the novel genre is the genre 2, the dimensions 7 to 22 may be taken as the comic image generation dimensions; and if the novel genre is the genre 3, the dimensions 15 to 30 may be taken as the comic image generation dimensions.

The keyword information may include at least one target keyword i.e., in a comic image generation dimension, at least one target keyword corresponding to a comic storyboard can be extracted. It may be understood that the more the keywords in a comic image generation dimension, the more abundant the information in the comic image generation dimension.

For example, the comic image generation dimensions may be preset, and include 16 preset dimensions, which are a character dimension, a scene dimension, a prop dimension, a costume dimension, a time dimension, an ambient light dimension, a shot language dimension, a shot dimension, a perspective dimension, an expression dimension, an action dimension, a human-object interaction dimension, a human-human interaction dimension, an object-object interaction dimension, a dialogue dimension, and an overlapping sound (OS) dimension, respectively.

In a specific implementation, after acquiring the target novel, a pre-trained novel storyboard model may be used to determine the number of comic episodes that can be split from the target novel and the comic storyboard corresponding to each episode of the comic according to the content of the target novel. Then, according to the content of the target novel, the keyword information corresponding to each of the comic storyboards in the plurality of the comic image generation dimensions is determined. The number of comic episodes may be understood as a chapter in a comic, and a chapter may include a plurality of comic images, i.e., a chapter may correspond to the plurality of the comic storyboards. As shown in Table 1 below, Table 1 is a tabular representation of a comic storyboard provided in an embodiment of the present disclosure.

TABLE 1

| | | | | | | Ambient | | | |
|---|---|---|---|---|---|---|---|---|---|
| No. | Scene | Character | Prop | Costume | Time | Light | Shot Language | Shot | Perspective |
| 1 | Bus stop | Character | Report | Costume | Day (i.e., | Backlight | Front, half-body shot, holding | Close | Eye level |
| | | A | sheet | A | daytime) | | a report sheet in both hands, | | |
| | | | | | | | appears in the middle of the | | |
| | | | | | | | picture as a foreground, with | | |
| | | | | | | | the head out of the frame | | |
| 2 | Bus stop | Character | Report | Costume | Daytime | Normal | Face the camera, with only | Close-up | Overlooking |
| | | A | sheet | A | | | the face in the frame. | | |
| 3 | Bus stop | Character | Prop A | Costume | Daytime | The sun is blazing, | Face the camera and appear | Far | Eye level |
| | | A | | A | | but character A | in the middle of the frame | | |
| | | | | | | is shrouded in | as a medium and long shot. | | |
| | | | | | | cold light. | | | |
| 4 | Hospital | Character | None | Costume | Daytime | Backlight | With the back to the camera, | Middle | Eye level |
| | | A: a doctor | | A: white gown | | | the character appears halfway | | |
| | | | | | | | into the frame and appears as | | |
| | | | | | | | the foreground on the left | | |
| | | | | | | | side of the frame. | | |
| 5 | Hospital | Character | None | Costume | Daytime | Normal | Side face the camera at an | Middle | Overlooking |
| | | A | | A | | | angle of 45 degrees. | | |
| 6 | Hospital | Character | None | Costume | Night | Normal | Face the camera. | Far | Eye level |
| | | A | | A | | | | | |

| | | | Human-Object | Human-Human | Object-Object | | Overlapping |
|---|---|---|---|---|---|---|---|
| No. | Expression | Action | Interaction | Interaction | Interaction | Dialogue | Sound |
| 1 | None | Sitting on | Holding a report | None | Object A is | XXXXXXX | According |
| | | a stool | sheet in the hand | | placed on | | to the report, |
| | | | | | Object B. | | XXXX. |
| 2 | Panic, with the | Sitting on | Holding a report | None | None | XXXXXX | XXXXXX |
| | eyes wide open. | a stool | sheet in the hand | | | | |
| 3 | None | Stand next | Hold prop A in | A hand of | The report sheet | XXXXXXXX | XXXXXXXXXX |
| | | to the | the hand. | character | is dropped on | | |
| | | stop sign. | | B rests on the | the ground. | | |
| | | | | shoulder of | | | |
| 4 | Sweating | Action A | Interaction | None | None | XXXX | XXXXX |
| | | | with prop A | | | | |
| 5 | Panic | Action B | Interaction with | Shake hands with | None | XXXXXXXXX | XXXX |
| | | | prop A and prop B | character B. | | | |
| 6 | Broken | Action C | Interaction with | None | Place prop A | XXXXXXXX | None |
| | hearted | | prop B | | on the ground. | | |

Each row in Table 1 corresponds to a comic storyboard, and the 16 columns of information corresponding to each row are the keyword information of the comic storyboard corresponding to the row in 16 dimensions. Table 1 includes the keyword information of 6 comic storyboards with serial number 1 to 6 in 16 dimensions. The 6 comic storyboards above correspond to a chapter in the comic. For example, the 6 comic storyboards in Table 1 above correspond to the chapter 1 of the comic. The comic storyboards of the chapter 2 to the chapter N may be expressed in a table as described in Table 1, the embodiment of the present disclosure will not repeat.

In one embodiment, the comic storyboards corresponding to the target novel may be determined as the following steps.

P1: splitting the target novel according to information semantics of text information corresponding to the target novel, and obtaining novel segments corresponding to the target novel.

Here, the text information corresponding to the target novel is the texts included in the content of the target novel. A novel segment may correspond to a comic storyboard and may also correspond to a chapter in a comic, and a chapter may include the plurality of the comic storyboards.

In a specific implementation, the pre-trained novel segmentation model may be used to perform semantic recognition on the text information corresponding to the target novel to obtain the information semantics. After that, according to the information semantics of the text information, the target novel is split to obtain the novel segments corresponding to the target novel.

Optionally, in order to further improve the splitting effect of the novel segments, according to the chapters of the target novel, the text information corresponding to the chapters may also be input into the novel segmentation model to obtain the novel segments corresponding to the chapters. Here, a novel segment may correspond to a comic storyboard.

P2: determining the comic storyboards corresponding to the target novel according to segmented texts of the novel segments and the comic image generation dimensions.

Here, the segmented text is the text in a novel segment.

In a specific implementation, a novel segmentation model can be used to perform the text extraction on the segmented texts of the novel segments according to the comic image generation dimensions, and the keyword information in the comic image generation dimensions can be obtained. Then, the comic storyboards corresponding to the novel segments can be obtained according to the keyword information in the comic image generation dimensions.

For example, after using the novel segmentation model to determine the novel segments, the texts of the novel segments can be cleaned up first to remove the invalid texts that are not related to the comic image generation. Then, the novel segmentation model can output a comic storyboard table as shown in Table 1 above according to the comic image generation dimensions and segmented texts, and a row in the comic storyboard table is a comic storyboard.

In one embodiment, the S102 above may be implemented as the following steps.

S102-1: determining occurrence numbers of each storyboard scene corresponding to the target novel according to the content of the target novel.

Here, the storyboard scene is a scene that appears in the target novel, and the storyboard scene corresponds to the scene dimension in Table 1 above. For example, the storyboard scene may be a bus stop, a hospital, an office, etc. The occurrence number is used to indicate the occurrence number of the storyboard scene in the target novel, and the more the occurrence number, the more important the storyboard scene.

In a specific implementation, after acquiring the target novel, according to the content of the target novel, the target novel can be split to determine the storyboard scenes in the target novel and the occurrence number corresponding to each storyboard scene can be determined.

S102-2: determining the keyword information separately corresponding to the comic storyboards that corresponds to the target novel in the plurality of the comic image generation dimensions according to the occurrence numbers, wherein an information amount of the keyword information is positively correlated with the occurrence number.

Here, the more the occurrence number of a storyboard scene, the more abundant the information amount corresponding to comic storyboards that have the storyboard scene, and the more abundant the target keywords in the keyword information. Conversely, the less the occurrence number of a storyboard, the smaller the information amount corresponding to comic storyboards that have the storyboard scene, and the briefer the target keyword in the keyword information.

In a specific implementation, after splitting the novel to obtain the comic storyboards, according to the occurrence number corresponding to the storyboard scene of the target storyboard in a scene dimension, the information amount of the storyboard scene in other comic image generation dimensions can be determined, and then the keyword information of the comic storyboard in the other comic image generation dimensions can be determined according to the information amount and the content of the target novel. In other words, the more the occurrence number of a storyboard scene, the more abundant the keyword information of the comic storyboard corresponding to the storyboard scene in other comic image generation dimensions except the scene dimension.

Thus, determining the keyword information according to the occurrence number of the storyboard scene, can improve the abundance of keyword information corresponding to important scenes, thereby providing the abundant target model input information to and obtaining more accurate and comprehensive comic images.

S103: with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords comprise a keyword that has been determined in any comic image generation dimension.

Here, the mapping library may be a dynamically maintained database, which is used to store the mapping relationships between the dimension keywords and the model input information. The model input information is used to characterize the constraint information when the artificial intelligence model is generating a comic image. The model input information may be understood as prompts. A target keyword in the keyword information may correspond to a piece of the model input information.

The dimension keywords of the mapping relationship stored in the mapping relationship library are the keywords that have been determined in any comic image generation dimension. The model input information in the mapping relationships is the prompts that have been determined to be matched with the dimension keywords.

The keyword information may include at least one target keyword, and a target keyword may correspond to a piece of target model input information. All the target model input information corresponding to the target keyword in the keyword information of the comic storyboards in the comic image generation dimensions is the target model input information corresponding to the comic storyboard.

In a specific implementation, after obtaining the keyword information corresponding to each of the comic storyboards in the plurality of the comic image generation dimensions, with respective to each of the comic storyboards, the target model input information that separately matches the keywords in the keyword information corresponding to the comic storyboard can be searched from the mapping relationship library.

For example, when the keyword information corresponding to the comic storyboard 1 includes the target keywords 1 to 10, the target dimension keywords that separately match the target keywords 1 to 10 can be searched from the dimension keywords in each mapping relationship stored in the mapping relationship library, and the model input information corresponding to each target dimension keyword is taken as the target model input information of the corresponding target keyword.

In one embodiment, the keyword information in each comic image generation dimension includes at least one target keyword. The mapping relationship library is used to store the mapping relationships between different dimension keywords and model input information, where the dimension keywords and model input information may be mapped with a one-to-one or many-to-one relationship. For example, with respective to the dimension keywords “smile”, “evil smile”, “slanted mouth smile”, etc., the corresponding model input information may be “smile”. With respective to the dimension keyword “shy”, the corresponding model input information may be “shy”.

With respective to the S103 above, the S103 may be implemented as the following steps:
when a target mapping relationship that matches the target keyword included in the keyword information is searched from the mapping relationships included in the mapping relationship library, taking model input information indicated by the target mapping relationship as the target model input information.

Here, a target keyword can correspond to at most one target mapping relationship, and the target mapping relationship is the mapping relationship between the dimension keywords and the target keyword of the mapping relationships.

In a specific implementation, with respective to the keyword information of any comic storyboard in any comic image generation dimension, the target keywords included in the keyword information may be first determined. Then, with respective to each target keyword, whether a target mapping relationship that matches the target keyword exists can be searched in the mapping relationships included in the mapping relationship library. In response to the target mapping relationship that matches the target keyword existing, the model input information of the target mapping relationship can be taken as the target model input information corresponding to the target keyword. Thus, with respective to the target keywords in the keyword information corresponding to the comic storyboards, the mapping relationship library can be tried to be used to search the corresponding target model input information.

In response to no target mapping relationship that matches the target keyword existing, the method in the steps 1 to 3 or the S1 to S3 below may be referred to determine the target model input information corresponding to the target keyword.

The mapping relationship corresponding to the target keyword can be determined as the following steps:
taking a mapping relationship corresponding to a dimension keyword that is consistent with the target keyword in the mapping relationship library as the target mapping relationship;
or, determining the target mapping relationship according to correlation degrees between keyword semantics of the dimension keywords of the mapping relationships in the mapping relationship library and a target semantic of the target keyword.

Here, the keyword semantics are used to indicate the semantics of the dimension keywords, and the target semantics are used to indicate the semantic of the target keyword. The correlation degree is used to indicate the semantic proximity between the target keyword and the dimension keyword. The higher the correlation degree, the closer the meaning expressed by the target keyword and the dimension keyword, and the lower the correlation degree, the greater the gap between the meaning expressed by the target keyword and the dimension keyword.

In a specific implementation, with respective to any target keyword, whether a target dimension keyword consistent with the target keyword exists may be searched from the dimension keywords of the mapping relationships included in the mapping relationship library, and in response to searching that the target dimension keyword consistent with the target keyword exists, then the mapping relationship corresponding to the target dimension keyword may be taken as the target mapping relationship corresponding to the target keyword. In response to searching that the target dimension keyword consistent with the target keyword does not exist, the correlation degrees between the keyword semantics of the dimension keywords and the target semantics may be determined, and then whether a target dimension keyword whose correlation degree is greater than a preset threshold exists may be determined. In response to a target dimension keyword whose correlation degree is greater than a preset threshold existing, the mapping relationship corresponding to the target dimension keyword may be taken as the target mapping relationship corresponding to the target keyword. The preset threshold may be set empirically, which is not limited specifically in the embodiments of the present disclosure.

In response to no target dimension keyword whose correlation degree is greater than a preset threshold existing, which can determine that the mapping relationship library does not store a target mapping relationship that matches the target keyword, then the steps 1 to 3 or the S1 to S3 below need to be used to determine the target model input information corresponding to the target keyword.

For example, assuming that the target keywords corresponding to any comic storyboard in any comic image generation dimension include the target keywords 1 to 3, with respective to the target keyword 1, whether a mapping relationship consistent with the target keyword 1 exists can be searched from the mapping relationship library. In response to the mapping relationship consistent with the target keyword 1 existing, the mapping relationship can be taken as the target mapping relationship corresponding to the target keyword 1, and the model input information in the target mapping relationship can be taken as the target model input information corresponding to the target keyword 1. In response to no mapping relationship consistent with the target keyword 1 existing, whether a target keyword whose correlation degree between the keyword semantic and the target semantic of the target keyword 1 is greater than a preset threshold can be searched from the mapping relationship library. In response to the target keyword whose correlation degree is greater than the preset threshold being searched, the mapping relationship corresponding to the target dimension keyword is taken as the target mapping relationship corresponding to the target keyword 1, and the model input information in the target mapping relationship is taken as the target model input information corresponding to the target keyword 1.

In response to no target dimension keyword whose correlation degree is greater than the preset threshold existing, the steps 1 to 3 or the S1 to S3 below may be used to determine the target model input information corresponding to the target keyword.

Specifically, when a target mapping relationship that matches the target keyword is not searched from the mapping relationship library, the target model input information corresponding to the target keyword can be determined as the steps 1 to 3 below.

Step 1: when no target mapping relationship that matches a target keyword included in the keyword information is stored in the mapping relationship library, determining pieces of candidate input information corresponding to the target keyword.

Here, the candidate input information is a plurality of input information that is generated according to the target keyword and may be taken as the model input information. Finally, the target model input information corresponding to the target keyword may be determined from the candidate input information.

In a specific implementation, with respective to any target keyword, when no target mapping relationship that matches the target keyword is stored in the mapping relationship library, the plurality of the candidate input information corresponding to the target keyword (i.e., the candidate prompt) can be generated according to the target semantic of the target keyword.

Step 2: inputting each candidate input information into the artificial intelligence model separately to obtain target images corresponding to each candidate input information.

Here, the artificial intelligence model is a pre-trained neural network model, which can output a corresponding image according to an input prompt. The target image is an image generated according to the candidate input information.

In a specific implementation, each candidate input information may be input into the artificial intelligence model separately to obtain the target image corresponding to each candidate input information output by the artificial intelligence model.

Step 3: determining the target model input information from the candidate input information according to matching degrees between the target images and the keyword information.

Here, the matching degree is used to characterize the fit degree between the image content of the target image and the keyword information to which the target keyword belongs. When the keyword information includes only one target keyword, the matching degree is used to characterize the fit degree between the image content of the target image and the target keyword.

In a specific implementation, after obtaining the target images, the matching degrees between the image contents of the target images and the information semantic of the keyword information to which the target keyword belongs can be calculated, and then the candidate input information corresponding to the target image with the highest matching degree can be taken as the target model input information.

Thus, according to the matching degrees between the target images and the keyword information, the candidate input information with the best image generation effect and the most accurate image content can be filtered out, and the candidate input information can be taken as the target model input information, which can improve the rationality and accuracy of the determined target model input information.

In another embodiment, when a target mapping relationship that matches the target keyword is not searched from the mapping relationship library, the target model input information corresponding to the target keyword can be determined as the S1 to S3 below.

S1: when no target mapping relationship that is related to a target keyword included in the keyword information is stored in the mapping relationship library, determining pieces of candidate input information corresponding to the target keyword.

For example, with respect to the keyword information of the comic storyboard in any comic image generation dimension, when anyone of the target keywords included in the keyword information does not have a matching target mapping relationship in the mapping relationship library, the plurality of the candidate input information corresponding to the target keyword can be generated according to the target semantic of the target keyword.

S2: with respect to anyone of the candidate input information, using a plurality of text-and-image conversion models separately to generate corresponding target images according to the candidate input information, wherein different text-and-image conversion models are deployed with different text-and-image conversion algorithms.

Here, the text-and-image conversion model may be any model that already exists, and has the ability to generate images according to text information. Different text-and-image conversion models are deployed with different text-and-image conversion algorithms, and the text-and-image conversion methods correspond to different text-and-image conversion algorithms are different.

In a specific implementation, after obtaining the candidate input information, i.e., after obtaining the candidate prompts, with respect to each candidate prompt, the candidate prompt can be input into different text-and-image conversion models separately to obtain the target images separately output by the text-and-image conversion models.

S3: determining an image generation effect of the candidate input information according to the target images, and determining the target model input information corresponding to the comic storyboard according to the image generation effect of the candidate input information respectively.

Here, the image generation effect may characterize information such as the matching degree between the keyword information and the image content of the target image, the matching degree between the image content of the target image and the novel segment corresponding to the comic storyboard (the comic storyboard to which the keyword information belongs) in the target novel, the content quality of the image content, etc.

In a specific implementation, with respect to any candidate prompt, after obtaining the target images corresponding to the candidate prompt, the first matching degree between the image content of each target image and the keyword information, the second matching degrees between the image content of each target image and the novel segment corresponding to the comic storyboard in the target novel, and the content quality of the image content can be determined. Then, the image generation effect corresponding to the candidate prompt can be determined according to the first matching degrees, second matching degrees and content qualities of the target images corresponding to the candidate prompt. For example, the image generation effect corresponding to the candidate prompt can be determined according to the mean value of the first matching degrees, mean value of the second matching degrees, and mean value of the content qualities of the target images. Thus, by using the plurality of the text-and-image conversion models and candidate input information to generate images, the generation effects of the candidate input information in different text-and-image conversion models can be determined, and then, a balanced image generation effect corresponding to the candidate input information can be determined based on the generation effects of different text-and-image conversion models.

Then, according to the image generation effects corresponding to the candidate prompts, the candidate prompt with the best image generation effect can be filtered out from the candidate prompts, and the candidate prompt is taken as the target model input information corresponding to the target keyword, i.e., as the target model input information corresponding to the comic storyboard.

For example, with respect to the target keyword in the keyword information of any comic storyboard in any comic image generation dimension, whether a target mapping relationship that matches the target keyword exist can be searched from the mapping relationship library first. In response to the target mapping relationship that matches the target keyword existing, the prompt indicated by the target mapping relationship can be taken as the target prompt corresponding to the target keyword. In response to the target mapping relationship that matches the target keyword not existing, the target prompt corresponding to the target keyword may be determined as the steps 1 to 3 or the S1 to S3 above.

In one embodiment, after using the steps 1 to 3 or the S1 to S3 above to determine the target model input information corresponding to the target keyword, the target keyword and the target model input information can also be used to dynamically update the mapping relationship library. Specifically, a mapping relationship between the target model input information and the target keyword may be established and stored in the mapping relationship library.

For example, after determining the target model input information corresponding to the target keyword, the correlation relationship between the target model input information and the target keyword may be established and stored in the mapping relationship library. Thus, after extracting the target keyword from the target novel, the mapping relationship stored in the mapping relationship library can be directly used to obtain the target model input information.

S104: using an artificial intelligence model to generate the comic image corresponding to the comic storyboard according to the target model input information.

In a specific implementation, with respect to any comic storyboard, after obtaining the target model input information corresponding to the comic storyboard, i.e., after obtaining the target prompts corresponding to the comic storyboard, all the target model input information can be input to the artificial intelligence model together to obtain the comic image corresponding to the comic storyboard.

Alternatively, after obtaining the target model input information corresponding to the comic storyboard, the target model input information may also be classified to obtain the target model input information under different categories. Then, with respect to each category, all the target model input information under the category can be input to the artificial intelligence model together to obtain a category image under the category. Then, the category images under the categories can be stitched together to obtain a comic image.

For example, the target model input information related to the image background and the target model input information related to characters in the image may be determined first from the target model input information. Then, the target model input information related to the image background can be input to the artificial intelligence model together to obtain a background image. The target model input information related to the characters in the image is input to the artificial intelligence model together to obtain a character image. After that, the background image and the character image can be stitched together to obtain the comic image corresponding to the comic storyboard.

In one embodiment, after generating the comic image corresponding to the comic storyboard, a target strip comic corresponding to the target novel can also be generated as the steps below:

S201: determining storyboard frames corresponding to the comic storyboards according to the keyword information corresponding to each of the comic storyboards.

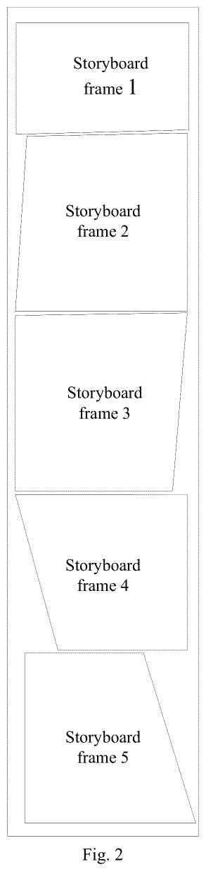

Here, the storyboard frame is an image area used to carry a comic image, and has size information and shape information. For example, the storyboard frame may be a rectangle, a parallelogram, an irregular polygon, etc. As shown in FIG. 2, which is a schematic diagram of a storyboard frame provided in an embodiment of the present disclosure, the comic storyboard frames (storyboard frames 1 to 5) corresponding to five storyboards are shown, and the sizes and shapes of each storyboard frame are different.

In a specific implementation, with respect to each of the comic storyboards, the keyword information of the comic storyboard in a plurality of comic image generation dimensions, or the novel segment corresponding to the comic storyboard can be input to a pre-trained storyboard frame segmentation model to obtain the size information and shape information of the storyboard frame corresponding to the comic storyboard.

S202: filling the comic images corresponding to each of the comic storyboards in the storyboard frames to obtain storyboard images corresponding to each of the comic storyboards.

In a specific embodiment, with respective to each of the comic storyboards, the shape and size of the comic image can be adjusted according to the size information and shape information of the storyboard frame corresponding to the comic storyboard, and then the comic image after adjusting is filled in the storyboard frame corresponding to the comic storyboard, the storyboard image corresponding to the comic storyboard is obtained. The image content of the comic image before and after adjusting is not distorted. Simultaneously, in response to the storyboard image not including the information such as speech bubbles, special effects, etc., the storyboard image may also be filled with the speech bubble and the special effects to obtain the storyboard image after adjusting.

S203: according to a target number of episodes to which each of the comic storyboards belongs in a strip comic and a storyboard order of each of the comic storyboards in the target number of the episodes, typesetting the storyboard images corresponding to the comic storyboards to obtain a target strip comic corresponding to the target novel.

Here, the target number of episodes is the target chapter to which the comic storyboard belongs in the strip comic, and an episode may be understood as a chapter. The storyboard order of the storyboard in the target number of episodes is used to indicate the position of the storyboard in the target chapter. For example, the storyboard order may be that a comic storyboard is the first frame of the target chapter. The target strip comic is a generated complete strip comic that matches the target novel.

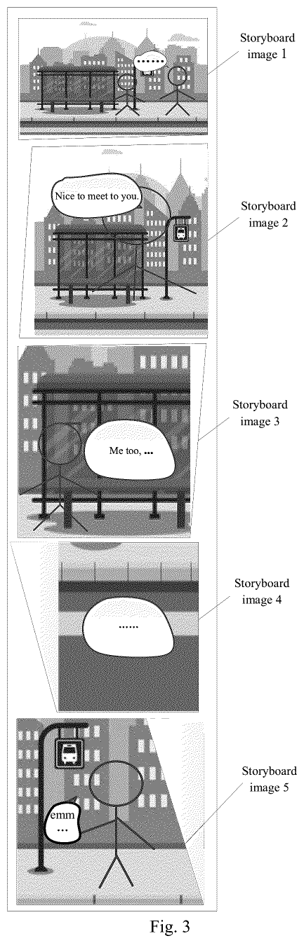

In a specific implementation, after obtaining the storyboard images of comic storyboards corresponding to the target novel, the target number of episodes to which each of the comic storyboards belongs in the strip comic can be determined, and the storyboard order corresponding to each of the comic storyboards in the target number of episodes can be determined. Then, according to the storyboard order, the storyboard images corresponding to each of the comic storyboards can be typeset from top to bottom to obtain the strip comic of a target episode. As shown in FIG. 3, which is a schematic diagram of a strip comic of a target episode provided in an embodiment of the present disclosure, the strip comic in FIG. 3 is obtained after filling the storyboard images of the target episode in the storyboard frames shown in FIG. 2, which includes 5 storyboard images (i.e., the storyboard images 1 to 5). After obtaining the strip comics corresponding to each target episode, the strip comics of each target episode may be combined into the target strip comic corresponding to the target novel according to the order of the episodes.

Thus, based on the process provided by the embodiments above, the automatic generation process from a target novel to a target strip comic can be implemented, which improve the efficiency of generating a comic.

Those skilled in the art may understand that in the above-mentioned method of the specific embodiments, the writing order of each step does not imply a strict order of execution and constitutes any limitation on the implementation process, and the specific order of execution of each step shall be determined by its function and possible internal logic.

Based on the same concept, the embodiments of the present disclosure further provide an apparatus of generating a comic image corresponding to the method of generating a comic image. Because the principle of the apparatus in the embodiments of the present disclosure solving problems is similar to the method of generating the comic image described above in the embodiments of the present disclosure, the implementation of the apparatus can refer to the implementation of the method, and the repetition will not be described again here.

As shown in FIG. 4, which is a schematic diagram of an apparatus of generating a comic image provided in an embodiment of the present disclosure, the apparatus includes an acquiring module 401, the first determining module 402, the second determining module 403 and the first generating module 404.

The acquiring module 401 is configured to acquire a target novel to be used to generate a comic.

The first determining module 402 is configured to determine keyword information corresponding to comic storyboards that correspond to the target novel in a plurality of comic image generation dimensions according to a content of the target novel.

The second determining module 403 is configured to, with respect to any comic storyboard of the comic storyboards, determine target model input information corresponding to the comic storyboard according to a mapping relationship library between dimension keywords and model input information, and the keyword information of the comic storyboards in the comic image generation dimensions. The dimension keywords comprise a keyword that has been determined in any comic image generation dimension.

The first generating module 404 is configured to use an artificial intelligence model, and generate a comic image corresponding to the comic storyboard according to the target model input information.

In a possible implementation, the keyword information includes at least one target keyword; the mapping relationship library is used for storing different mapping relationships between the dimension keywords and the model input information;
and when determining target model input information corresponding to the comic storyboard according to a mapping relationship library between dimension keywords and model input information and the keyword information of the comic storyboards in the comic image generation dimensions, the second determining module 403 is configured to:
when a target mapping relationship that matches the target keyword included in the keyword information is searched from the mapping relationships included in the mapping relationship library, take model input information indicated by the target mapping relationship as the target model input information.

In a possible implementation, the second determining module 403 is configured to search the target mapping relationship as following steps:
taking a mapping relationship corresponding to a dimension keyword that is consistent with the target keyword in the mapping relationship library as the target mapping relationship;
or, determining the target mapping relationship according to correlation degrees between keyword semantics of the dimension keywords of the mapping relationships in the mapping relationship library and a target semantic of the target keyword.

In a possible implementation, when determining target model input information corresponding to the comic storyboard according to a mapping relationship library between dimension keywords and model input information and the keyword information of the comic storyboards in the comic image generation dimensions, the second determining module 403 is configured to:
when the mapping relationship library does not store a target mapping relationship that matches a target keyword included in the keyword information, determine pieces of candidate input information corresponding to the target keyword;
input the plurality of the candidate input information into the artificial intelligence model separately to obtain target images corresponding to each candidate input information; and
determine the target model input information from the candidate input information according to matching degrees between the target images and the keyword information.

In a possible implementation, the apparatus further includes a storage module 405.

After determining the target model input information from the candidate input information, the storage module 405 is configured to establish a mapping relationship between the target model input information and the target keyword, and store the mapping relationship between the target model input information and the target keyword into the mapping relationship library.

In a possible implementation, when determining target model input information corresponding to the comic storyboard according to a mapping relationship library between dimension keywords and model input information and the keyword information of the comic storyboards in the comic image generation dimensions, the second determining module 403 is configured to:
when the mapping relationship library does not store a target mapping relationship that is related to a target keyword included in the keyword information, determine pieces of candidate input information corresponding to the target keyword;
with respect to anyone of the candidate input information, use a plurality of text-and-image conversion models separately, and generate corresponding target images according to the candidate input information, wherein different text-and-image conversion models are deployed with different text-and-image conversion algorithms; and
determine an image generation effect of the candidate input information according to the target images, and determine the target model input information corresponding to the comic storyboard according to the image generation effect of the candidate input information respectively.

In a possible implementation, when determining keyword information corresponding to comic storyboards that correspond to the target novel in a plurality of comic image generation dimensions according to a content of the target novel, the first determining module 402 is configured to:
determine occurrence numbers of each storyboard scene corresponding to the target novel according to the content of the target novel; and
determine the keyword information separately corresponding to the comic storyboards that corresponds to the target novel in the plurality of the comic image generation dimensions according to the occurrence numbers, wherein an information amount of the keyword information is positively correlated with the occurrence number.

In a possible implementation, the apparatus further includes the second generating module 406.

After generating the comic images corresponding to the comic storyboards, the second generating module 406 is configured to:
determine storyboard frames corresponding to the comic storyboards according to the keyword information corresponding to each of the comic storyboards;
fill the comic images corresponding to each of the comic storyboards in the storyboard frames to obtain storyboard images corresponding to each of the comic storyboards; and
according to a target number of episodes to which each of the comic storyboards belongs in a strip comic and a storyboard order of each of the comic storyboards in the target number of the episodes, typeset the storyboard images corresponding to the comic storyboards to obtain a target strip comic corresponding to the target novel.

In a possible implementation, the first determining module is further configured to determine the comic storyboards corresponding to the target novel as following steps:
splitting the target novel according to information semantics of text information corresponding to the target novel, and obtaining novel segments corresponding to the target novel; and
determining the comic storyboards corresponding to the target novel according to segmented texts of the novel segments and the comic image generation dimensions.

In a possible implementation, the apparatus further includes the third determining module 407.

The third determining module 407 is configured to determine the comic image generation dimensions as following steps:
determining a novel genre of the target novel; and
determining the plurality of the comic image generation dimensions corresponding to the target novel from a plurality of preset image generation dimensions according to the novel genre.

The description of the processing flow of modules in the apparatus and the interaction flow between the modules can refer to the relevant description in the above-mentioned method embodiments, which is not described in detail here.

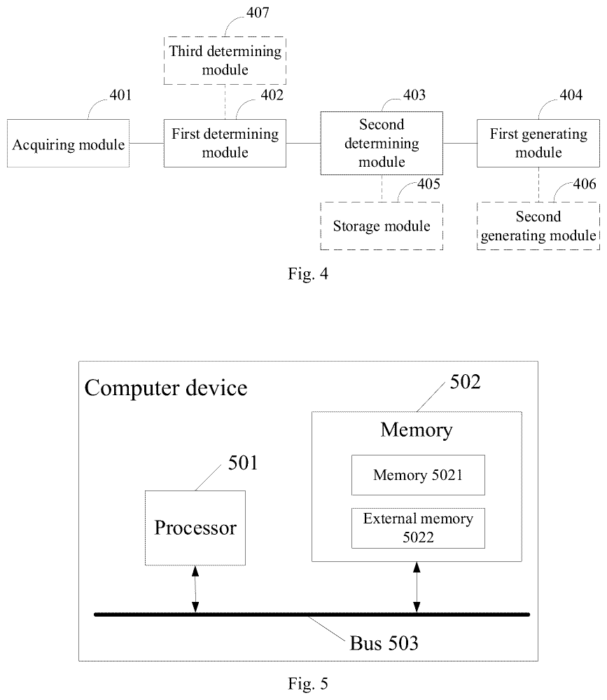

Based on the same technical conception, the embodiments of the present disclosure further provide a computer device. With reference to FIG. 5, which is a structural schematic diagram of a computer device provided in an embodiment of the present disclosure, the computer device includes a processor 501, a memory 502 and a bus 503.

The memory 502 stores machine-readable instructions that can be executed by the processor 501. The processor 501 is configured to execute the machine-readable instructions stored in the memory 502, and when the machine-readable instructions are executed by the processor 501, the processor 501 executes the following steps: S101: acquiring a target novel to be used to generate a comic; S102: according to a content of the target novel, determining keyword information corresponding to comic storyboards that correspond to the target novel in a plurality of comic image generation dimensions; S103: with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords comprise a keyword that has been determined in any comic image generation dimension; and S104: using an artificial intelligence model to generate a comic image corresponding to the comic storyboard according to the target model input information.

The memory 502 includes a memory 5021 and an external memory 5022. The memory 5021 herein is also called internal memory, which is used for temporarily storing the operation data in the processor 501 and the data exchanged with the external memory 5022 such as the hard disk, etc. The processor 501 exchanges data with the external memory 5022 through the memory 5021, and when the computer device is running, the processor 501 communicates with the memory 502 through the bus 503, causing the processor 501 to execute the execution instructions mentioned in the method embodiments above.

The embodiments of the present disclosure further provide a non-transitory computer-readable storage medium. The non-transitory computer-readable storage medium stores computer programs, and when the computer programs are executed by a processor, the processor executes the steps of method of generating a comic image in above-mentioned method implementations. The storage medium may be a volatile or non-volatile computer-readable storage medium.

The computer program product of the method of generating a comic image provided in the embodiments of the present disclosure, includes a computer-readable storage medium that stores program codes, and the instructions included in the program codes can be used to execute the steps of the method of generating the comic image in the above-mentioned method embodiments, which can specifically refer to the above-mentioned method embodiments, and will not be repeated herein.

The computer program product may be implemented in hardware, software, or a combination thereof. In one optional embodiment, the computer program product is specifically embodied as a computer storage medium, and in another optional embodiment, the computer program product is specifically embodied in a software product, such as a software development kit (SDK), etc.

Those skilled in the art can clearly understand that, for the convenience and conciseness of the description, the specific working process of the apparatus described above may refer to the corresponding process in the aforesaid method embodiments, which will not be repeated herein. In some embodiments provided in the present disclosure, it should be understood that the apparatus and method disclosed can be implemented by other means. The apparatus embodiments described above are only schematic, for example, the division of the units is only a logical function division, and there may be another division method when the apparatus is actually implemented, and for example, a plurality of units or components can be combined, or some features can be ignored or not executed. On the other hand, the coupling or direct coupling or communication connection between each other shown or discussed may be indirect coupling or communication connection through some communication interfaces, apparatuses or units, which may be in electrical, mechanical or other form.

The unit described as a separate component may be or may not be physically separated, and the component displayed as a unit may be or may not be a physical unit, i.e., may be located in a place, or may also be distributed on a plurality of network units. Some or all of the units can be selected according to actual needs to implement the purpose of the present embodiment solution.

In addition, the functional units in the embodiments of the present disclosure may be integrated in a processing unit, or each unit may exist separately physically, or two or more than two units may be integrated in a unit.

If the described function is implemented in the form of a software functional unit and marketed or used as an independent product, the function may be stored in a non-volatile computer-readable storage medium that can be executed by a processor. Based on this understanding, the technical solution of the present disclosure in essence or the part that contributes to the prior art or the part of the technical solution may be embodied in the form of a software product, and the computer software product is stored in a storage medium that includes several instructions for enabling a computer device (which may be a personal computer, a server, or a network device, etc.) to execute all or part of the steps of the method described in the embodiments of the present disclosure. The aforementioned storage medium includes various media that can store program codes, such as a USB flash drive, a mobile hard disk, a Read-Only Memory (ROM), a Random Access Memory (RAM), a disk, an optical disc, etc.

If the technical solutions of the present disclosure involve personal information, before processing personal information, the products that apply the technical solutions of the present disclosure have clearly informed the personal information processing rules and obtained the individual's independent consent. If the technical solutions of the present disclosure involve sensitive personal information, before processing sensitive personal information, the products that apply the technical solutions of the present disclosure have obtained the individual's separate consent, and satisfied the requirement of “express consent” at the same time. For example, at a personal information collection apparatus such as a camera, etc., a clear and conspicuous sign is set up to inform that the personal information collection scope has been entered and that the personal information will be collected, and if the individual voluntarily enters the collection scope, it will be deemed that the individual agrees the collection of the personal information. Or, on the personal information processing apparatus, when a conspicuous mark/information is used to inform the personal information processing rules, the individual's authorization is obtained by means of a pop-up window or by asking the individual to upload his or her personal information. The personal information processing rules may include information such as the person who processes the personal information, the purpose of personal information processing, the method of processing, the types of personal information processed, etc.

Finally, it should be noted that the above-mentioned embodiments are only specific embodiments of the present disclosure, which are used to illustrate the technical solutions of the present disclosure and not to limit them, and the scope of protection of the present disclosure is not limited to this. Although the present disclosure is described in detail with reference to the aforesaid embodiments, a person skilled in the art should understand that any person skilled in the art who is familiar with the art can still modify the technical solutions described in the aforesaid embodiments or can easily think of changes within the scope of the technology disclosed in the disclosure, or the equivalent substitution of some of the technical features. These modifications, changes or substitutions do not depart the essence of the corresponding technical solutions from the spirit and scope of the technical solutions of the embodiments of the present disclosure, which shall be covered in the scope of protection of the present disclosure. Therefore, the scope of protection of the present disclosure shall be stated in accordance with the scope of protection of the claims.

1. A method of generating a comic image, comprising:
acquiring a target novel to be used to generate a comic;
determining keyword information corresponding to comic storyboards that correspond to the target novel in a plurality of comic image generation dimensions according to a content of the target novel;
with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords comprise a keyword that has been determined in any comic image generation dimension; and
using an artificial intelligence model to generate a comic image corresponding to the comic storyboard according to the target model input information.

2. The method according to claim 1, wherein the keyword information comprises at least one target keyword; the mapping relationship library is used for storing different mapping relationships between the dimension keywords and the model input information;
the determining target model input information corresponding to the comic storyboard according to a mapping relationship library between dimension keywords and model input information, and the keyword information of the comic storyboards in the comic image generation dimensions, comprises:
when a target mapping relationship that matches the target keyword comprised in the keyword information is searched from the mapping relationships included in the mapping relationship library, taking model input information indicated by the target mapping relationship as the target model input information.

3. The method according to claim 2, wherein the target mapping relationship is searched as following steps:
taking a mapping relationship corresponding to a dimension keyword that is consistent with the target keyword in the mapping relationship library as the target mapping relationship; or
determining the target mapping relationship according to correlation degrees between keyword semantics of the dimension keywords of the mapping relationships in the mapping relationship library and a target semantic of the target keyword.

4. The method according to claim 1, wherein the determining target model input information corresponding to the comic storyboard according to a mapping relationship library between dimension keywords and model input information, and the keyword information of the comic storyboards in the comic image generation dimensions, comprises:
when the mapping relationship library does not store a target mapping relationship that matches a target keyword comprised in the keyword information, determining pieces of candidate input information corresponding to the target keyword;
inputting each candidate input information into the artificial intelligence model separately to obtain target images corresponding to each candidate input information; and
determining the target model input information from the candidate input information according to matching degrees between the target images and the keyword information.

5. The method according to claim 4, wherein after the determining the target model input information from the candidate input information, the method further comprises:
establishing a mapping relationship between the target model input information and the target keyword, and storing the mapping relationship between the target model input information and the target keyword into the mapping relationship library.

6. The method according to claim 1, wherein the determining target model input information corresponding to the comic storyboard according to a mapping relationship library between dimension keywords and model input information, and the keyword information of the comic storyboards in the comic image generation dimensions, comprises:
when the mapping relationship library does not store a target mapping relationship that is related to a target keyword comprised in the keyword information, determining pieces of candidate input information corresponding to the target keyword;
with respect to anyone of the candidate input information, using a plurality of text-and-image conversion models separately to generate corresponding target images according to the candidate input information, wherein different text-and-image conversion models are deployed with different text-and-image conversion algorithms; and
determining an image generation effect of the candidate input information according to the target images, and determining the target model input information corresponding to the comic storyboard according to the image generation effect of the candidate input information respectively.

7. The method according to claim 1, wherein the determining keyword information corresponding to comic storyboards that correspond to the target novel in a plurality of comic image generation dimensions according to a content of the target novel, comprises:
determining occurrence numbers of each storyboard scene corresponding to the target novel according to the content of the target novel; and
determining the keyword information separately corresponding to the comic storyboards that corresponds to the target novel in the plurality of the comic image generation dimensions according to the occurrence numbers, wherein an information amount of the keyword information is positively correlated with the occurrence number.

8. The method according to claim 1, wherein after generating the comic images corresponding to the comic storyboards, the method further comprises:
determining storyboard frames corresponding to the comic storyboards according to the keyword information corresponding to each of the comic storyboards;
filling the comic images corresponding to each of the comic storyboards in the storyboard frames to obtain storyboard images corresponding to each of the comic storyboards; and
according to a target number of episodes to which each of the comic storyboards belongs in a strip comic and a storyboard order of each of the comic storyboards in the target number of the episodes, typesetting the storyboard images corresponding to the comic storyboards to obtain a target strip comic corresponding to the target novel.

9. The method according to claim 1, wherein the comic storyboards corresponding to the target novel is determined as following steps:
splitting the target novel according to information semantics of text information corresponding to the target novel, and obtaining novel segments corresponding to the target novel; and
determining the comic storyboards corresponding to the target novel according to segmented texts of the novel segments and the comic image generation dimensions.

10. The method according to claim 1, wherein the comic image generation dimensions are determined as following steps:
determining a novel genre of the target novel; and
determining the plurality of the comic image generation dimensions corresponding to the target novel from a plurality of preset image generation dimensions according to the novel genre.

11. A computer device, comprising:
at least one processor and a memory;
wherein the memory stores machine-readable instructions executed by the at least one processor, the at least one processor is configured to execute the machine-readable instructions stored in the memory, and when the machine-readable instructions are executed by the at least one processor, the at least one processor executes a method of generating a comic image, the method of generating the comic image comprises:
acquiring a target novel to be used to generate a comic;
determining keyword information corresponding to comic storyboards that correspond to the target novel in a plurality of comic image generation dimensions according to a content of the target novel;
with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords comprise a keyword that has been determined in any comic image generation dimension; and
using an artificial intelligence model to generate a comic image corresponding to the comic storyboard according to the target model input information.

12. The computer device according to claim 11, wherein the keyword information comprises at least one target keyword; the mapping relationship library is used for storing different mapping relationships between the dimension keywords and the model input information;
the determining target model input information corresponding to the comic storyboard according to a mapping relationship library between dimension keywords and model input information, and the keyword information of the comic storyboards in the comic image generation dimensions, comprises:
when a target mapping relationship that matches the target keyword comprised in the keyword information is searched from the mapping relationships included in the mapping relationship library, taking model input information indicated by the target mapping relationship as the target model input information.

13. The computer device according to claim 12, wherein the target mapping relationship is searched as following steps:
taking a mapping relationship corresponding to a dimension keyword that is consistent with the target keyword in the mapping relationship library as the target mapping relationship;
or, determining the target mapping relationship according to correlation degrees between keyword semantics of the dimension keywords of the mapping relationships in the mapping relationship library and a target semantic of the target keyword.

14. The computer device according to claim 11, wherein the determining target model input information corresponding to the comic storyboard according to a mapping relationship library between dimension keywords and model input information, and the keyword information of the comic storyboards in the comic image generation dimensions, comprises:
when the mapping relationship library does not store a target mapping relationship that matches a target keyword comprised in the keyword information, determining pieces of candidate input information corresponding to the target keyword;
inputting each candidate input information into the artificial intelligence model separately to obtain target images corresponding to each candidate input information; and
determining the target model input information from the candidate input information according to matching degrees between the target images and the keyword information.

15. The computer device according to claim 11, wherein the determining target model input information corresponding to the comic storyboard according to a mapping relationship library between dimension keywords and model input information, and the keyword information of the comic storyboards in the comic image generation dimensions, comprises:
when the mapping relationship library does not store a target mapping relationship that is related to a target keyword comprised in the keyword information, determining pieces of candidate input information corresponding to the target keyword;
with respect to anyone of the candidate input information, using a plurality of text-and-image conversion models separately to generate corresponding target images according to the candidate input information, wherein different text-and-image conversion models are deployed with different text-and-image conversion algorithms; and
determining an image generation effect of the candidate input information according to the target images, and determining the target model input information corresponding to the comic storyboard according to the image generation effect of the candidate input information respectively.

16. The computer device according to claim 11, wherein the determining keyword information corresponding to comic storyboards that correspond to the target novel in a plurality of comic image generation dimensions according to a content of the target novel, comprises:
determining occurrence numbers of each storyboard scene corresponding to the target novel according to the content of the target novel; and
determining the keyword information separately corresponding to the comic storyboards that corresponds to the target novel in the plurality of the comic image generation dimensions according to the occurrence numbers, wherein an information amount of the keyword information is positively correlated with the occurrence number.

17. The computer device according to claim 11, wherein after generating the comic images corresponding to the comic storyboards, the method further comprises:
determining storyboard frames corresponding to the comic storyboards according to the keyword information corresponding to each of the comic storyboards;
filling the comic images corresponding to each of the comic storyboards in the storyboard frames to obtain storyboard images corresponding to each of the comic storyboards; and
according to a target number of episodes to which each of the comic storyboards belongs in a strip comic and a storyboard order of each of the comic storyboards in the target number of the episodes, typesetting the storyboard images corresponding to the comic storyboards to obtain a target strip comic corresponding to the target novel.

18. The computer device according to claim 11, wherein the comic storyboards corresponding to the target novel is determined as following steps:
splitting the target novel according to information semantics of text information corresponding to the target novel, and obtaining novel segments corresponding to the target novel; and
determining the comic storyboards corresponding to the target novel according to segmented texts of the novel segments and the comic image generation dimensions.

19. The computer device according to claim 11, wherein the comic image generation dimensions are determined as following steps:
determining a novel genre of the target novel; and
determining the plurality of the comic image generation dimensions corresponding to the target novel from a plurality of preset image generation dimensions according to the novel genre.

20. A non-transitory computer-readable storage medium, wherein the non-transitory computer-readable storage medium stores computer programs, when the computer programs are executed by a computer device, the computer device executes a method of generating a comic image, and the method of generating the comic image comprises:
acquiring a target novel to be used to generate a comic;
determining keyword information corresponding to comic storyboards that correspond to the target novel in a plurality of comic image generation dimensions according to a content of the target novel;
with respect to any comic storyboard of the comic storyboards, determining target model input information corresponding to the comic storyboard according to a mapping relationship library between dimension keywords and model input information, and the keyword information of the comic storyboards in the comic image generation dimensions, wherein the dimension keywords comprise a keyword that has been determined in any comic image generation dimension; and
using an artificial intelligence model to generate a comic image corresponding to the comic storyboard according to the target model input information.
